(19) United States
(12) Patent Application Publication
(10) Pub. No.: US 2023/0367936 A1
(43) Pub. Date: Nov. 16, 2023

(54) VERIFICATION METHOD, ELECTRONIC DEVICE AND STORAGE MEDIUM

(71) Applicant: XEPIC CORPORATION LIMITED, Nanjing (CN)

(72) Inventors: Ye YANG, Shanghai (CN); Lifeng XU, Shanghai (CN)

(21) Appl. No.: 18/313,654

(22) Filed: May 8, 2023

(30) Foreign Application Priority Data
May 10, 2022 (CN) 202210507872.1

(51) Int. Cl. G06F 30/33; G06F 30/31

(52) U.S. Cl. CPC G06F 30/33; G06F 30/31

(57) ABSTRACT

Embodiments of the disclosure provide a method, electronic device and storage medium for verifying logic system design. The method includes: receiving a verification goal of a user; according to the verification goal, invoking a plurality of verification tools through an invoking interface of an integration tool; generating a multi-tool verification process based on the verification goal and the plurality of verification tools; and invoking the plurality of verification tools according to the multi-tool verification process to achieve the verification goal.

### CROSS REFERENCE TO RELATED APPLICATION

The application claims the benefits of priority to Chinese Application No. 202210507872.1, filed May 10, 2022, which is incorporated herein in its entirety.

### TECHNICAL FIELD

The present disclosure relates to the technical field of computer software, in particular to a method, electronic device, and storage medium for verifying a logic system design.

### BACKGROUND

In the field of verifying integrated circuits, simulation generally refers to compiling a logic system design and running the logic system design on a computer to simulate and test various functions of the logic system design. The logic system design may be, for example, the design of an application-specific integrated circuit (ASIC) or a System-On-Chip (SOC). Therefore, the design tested or verified in the simulation can also be called the Device Under Test (DUT).

Along with the expansion of chip design scale, the number of verification tools required to verify a logic system design also increases. However, there is currently a lack of synergy among the various verification tools. Users cannot conveniently use multiple verification tools for collaborative verification.

### SUMMARY

In accordance with the disclosure, there is provided a verification method, an electronic device, and a storage medium.

A first aspect of the present disclosure provides a method of verifying a logic system design. The method includes: receiving a verification goal of a user; according to the verification goal, invoking a plurality of verification tools through an invoking interface of an integration tool; generating a multi-tool verification process based on the verification goal and the plurality of verification tools; and invoking the plurality of verification tools according to the multi-tool verification process to achieve the verification goal.

A second aspect of the present disclosure provides an electronic device. The electronic device includes: a memory storing a set of instructions; and at least one processor configured to execute the set of instructions to perform a method of verifying a logical system design, wherein the method comprises: receiving a verification goal of a user; according to the verification goal, invoking a plurality of verification tools through an invoking interface of an integration tool; generating a multi-tool verification process based on the verification goal and the plurality of verification tools; and invoking the plurality of verification tools according to the multi-tool verification process to achieve the verification goal.

A third aspect of the present disclosure provides a non-transitory computer-readable storage medium storing a set of instructions that, when executed by a processor, causes the processor to perform a method for verifying a logical system design, the method comprising: receiving a verification goal of a user; according to the verification goal, invoking a plurality of verification tools through an invoking interface of an integration tool; generating a multi-tool verification process based on the verification goal and the plurality of verification tools; and invoking the plurality of verification tools according to the multi-tool verification process to achieve the verification goal.

The verification method, electronic device and storage medium provided in the present disclosure enable users to flexibly design the verification functions they need by integrating and further editing the capabilities of multiple verification tools through the integration tool, which improves the efficiency of the user's verification of the logic system design. In addition, when the user temporarily lacks an individual verification tool locally, the integration tool provided by embodiments of the present disclosure can also use the individual verification tool on the cloud to meet the temporary needs of users.

### BRIEF DESCRIPTION OF THE DRAWINGS

To describe the technical solutions in the present disclosure, the following will briefly introduce the figures that need to be used in the embodiments. Obviously, the figures in the following description are merely exemplary, for those ordinary skilled in the art, without inventive work, other figures can be obtained based on these figures.

FIG. 1A illustrates a schematic diagram of an exemplary electronic device according to embodiments of the present disclosure.

FIG. 1B illustrates a collection of exemplary verification tools according to embodiments of the present disclosure.

FIG. 2 illustrates a schematic diagram of an integration tool according to embodiments of the present disclosure.

FIG. 3 illustrates a schematic diagram of a verification tool on the cloud according to embodiments of the present disclosure.

FIG. 4 illustrates a schematic diagram of a process for processing a verification goal according to embodiments of the present disclosure.

FIG. 5 illustrates a flow chart of a method for verifying a logic system design according to embodiments of the present disclosure.

### DETAILED DESCRIPTION

Exemplary embodiments will be described in detail herein, and examples thereof are shown in the accompanying drawings. In the following description involving the accompanying drawings, the same numerals in different accompanying drawings indicate the same or similar elements, unless specified otherwise. Implementations described in the following exemplary embodiments do not represent all implementations consistent with the disclosure. In contrast, they are merely examples of devices and methods consistent with some aspects of the disclosure as described in detail below.

Terms in the disclosure are merely used for describing specific embodiments, rather than limiting the disclosure. Singular-form words “a (an)”, “said”, and “the” used in the present disclosure including the appended claims also include plural forms, unless clearly specified in the context that other meanings are denoted. It should be further understood that the term “and/or” used herein refers to and includes any or all possible combinations of one or more associated items listed.

It should be understood that, although terms such as “first”, “second”, and “third” may be used to describe various kinds of information in the disclosure, these kinds of information should not be limited by the terms. These terms are merely used to distinguish information of the same type from each other. For example, without departing from the scope of the disclosure, the first information may also be referred to as second information, and similarly, the second information may also be referred to as first information. Depending on the context, the word “if” used herein may be explained as “when . . . ”, “as . . . ”, or “in response to the determination”.

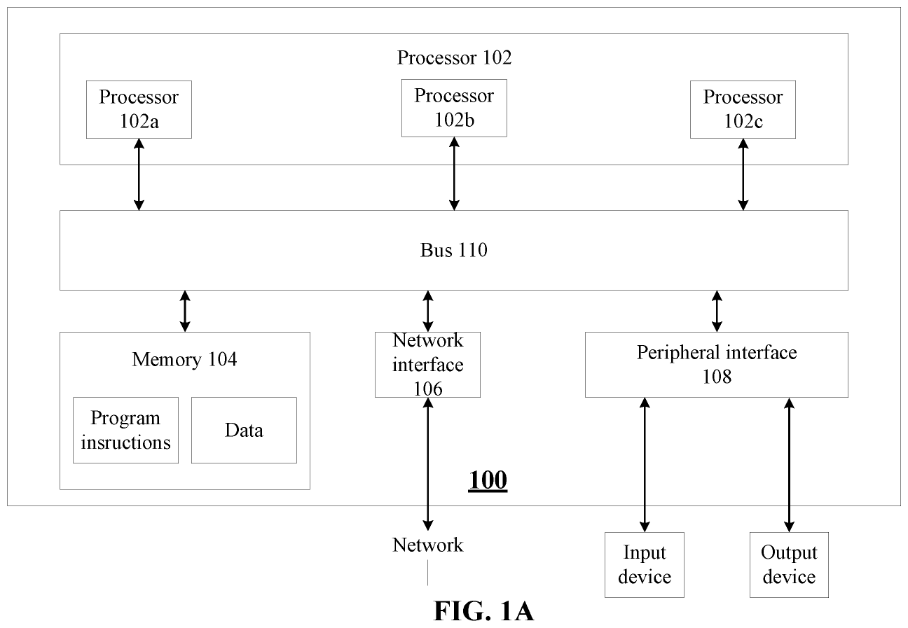

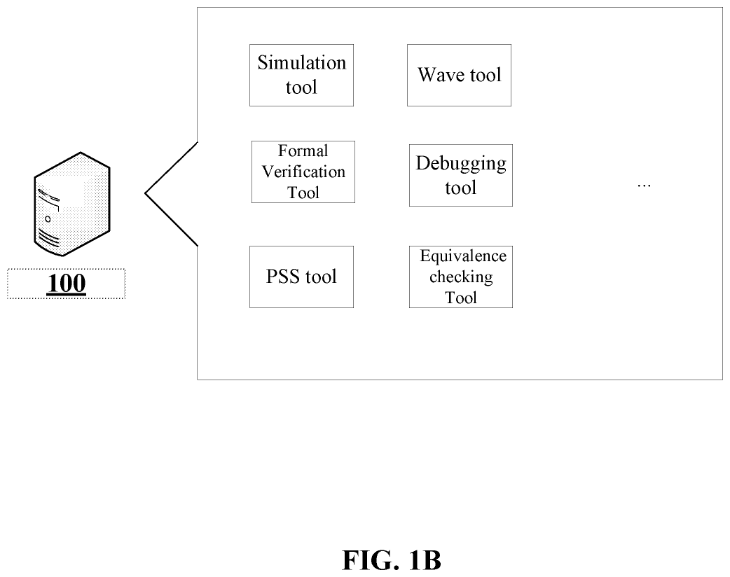

FIG. 1A illustrates a schematic diagram of an electronic device 100 according to embodiments of the present disclosure. The electronic device 100 can be, for example, a computer host machine. The electronic device 100 can include: a processor 102, a memory 104, a network interface 106, a peripheral interface 108, and a bus 110. The processor 102, the memory 104, the network interface 106, and the peripheral interface 108 are connected to each other within the device 100 through the bus 110.

The processor 102 can be a central processing unit (CPU), an image processor, a neural network processor (NPU), a micro control unit (MCU), a programmable logical device, a digital signal processor (DSP), an application specific integrated circuit (ASIC), or one or more integrated circuits. The processor 102 can perform functions related to the techniques described in the disclosure. In some embodiments, the processor 102 can also include a plurality of processors integrated into a single logical component. As shown in FIG. 1A, the processor 102 can include a plurality of processors 102a, 102b, and 102c.

The memory 104 can be configured to store data (e.g., an instruction set, computer codes, intermediate data, and the like). As shown in FIG. 1A, the stored data can include program instructions (e.g., program instructions used to implement the simulation method of the present disclosure) and the data to be processed (e.g., the memory 104 can store temporary codes generated during compiling). The processor 102 can also access stored program instructions and data, and execute the program instructions to operate the data to be processed. The memory 104 can include a non-transitory computer-readable storage medium, such as a volatile storage device or a non-volatile storage device. In some embodiments, the memory 104 can include a random-access memory (RAM), a read-only memory (ROM), an optical disk, a magnetic disk, a hard disk, a solid-state disk (SSD), a flash memory, a memory stick, and the like.

The network interface 106 can be configured to enable the electronic device 100 to communicate with other external devices via a network. The network can be any wired or wireless network capable of transmitting and receiving data. For example, the network can be a wired network, a local wireless network (e.g., a Bluetooth network, a Wi-Fi network, a near field communication (NFC), or the like), a cellular network, the Internet, or a combination of the above. It is appreciated that the type of network is not limited to the above specific examples. In some embodiments, the network interface 106 can include any number of network interface controllers (NICs), radio frequency modules, receivers, modems, routers, gateways, adapters, cellular network chips, or random combinations of two or more of the above.

The peripheral interface 108 can be configured to connect the electronic device 100 to one or more peripheral devices to implement input and output information. For example, the peripheral devices can include input devices, such as keyboards, mice, touch pads, touch screens, microphones, various sensors, and output devices, such as displays, speakers, vibrators, and indicator lights.

The bus 110, such as an internal bus (e.g., a processor-storage bus), an external bus (e.g., a USB port, a PCI-E bus), and the like, can be configured to transmit information among various components (e.g., the processor 102, the memory 104, the network interface 106, and the peripheral interface 108) of electronic device 100.

It should be noted that, although the above device merely illustrates the processor 102, the memory 104, the network interface 106, the peripheral interface 108, and the bus 110, the device can also include other components necessary for normal operations. In addition, it can be appreciated for those ordinary skilled in the art that the foregoing devices can also include the components necessary to implement the solutions of embodiments of the present disclosure and do not require to include all the components of figures.

FIG. 1B illustrates a collection of exemplary verification tools according to embodiments of the present disclosure.

As shown in FIG. 1B, in the verification process of a logic system design (for example, a chip design), various verification tools may be involved, such as simulation tools, formal verification tools, PSS (Portable Stimulus Standard) tools, waveform tools, debugging tools, equivalence checking (EC) tools, and the like. In the related art, these verification tools can only be run independently, but cannot be integrated.

However, in an actual verification process of a logic system design (for example, a chip design), cooperation of multiple tools is always needed to achieve high-efficiency verification.

To solve the above problems, embodiments of the present disclosure provide a verification method, an electronic device and a storage medium, to efficiently integrate various verification tools and facilitate verification users to realize their customized functions.

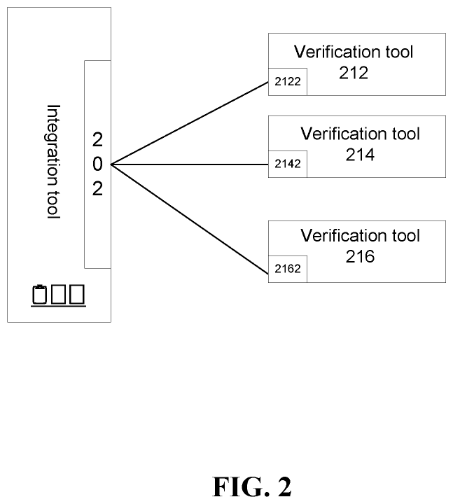

FIG. 2 illustrates a schematic diagram of an integration tool 200 according to embodiments of the present disclosure.

The integration tool 200 can include an invoking interface 202. The integration tool 200 can be connected with interfaces of multiple verification tools via the invoking interface 202. For example, the invoking interface 202 of the integration tool 200 can be communicatively connected to the interfaces 2122, 2142, and 2162 of verification tools 212, 214, and 216, for using the verification tools 212, 214, and 216. It is appreciated that one invoking interface 202 in the present disclosure can include multiple sub-interfaces. In other words, the invoking interface 202 can invoke multiple verification tools at a time.

The verification tools 212, 214, 216 can include various verification tools, such as a software simulation tool, a formal verification tool, a hardware simulation tool, a debugging tool, or the like. The key unit of software simulation can be a host machine having one or more CPUs, and the key unit of hardware emulation can be an FPGA chip or a dedicated chip and a circuit system associated therewith. Each verification tool has a corresponding amount of hardware or software resources. The integration tool 200 can be connected to the interfaces 2122, 2142, and 2162 of the verification tools 212, 214, and 216 via the invoking interface 202, to collect the currently-available resources (software or hardware) of each verification tool, so as to provide supporting information for the subsequent verification process and verification task scheduling.

The interfaces 2122, 2142 and 2162 can be application programming interfaces (API) or command line invoking interfaces, and are used to provide capabilities of the verification tools 212, 214 and 216 to tools that initiate invoking requests through the interfaces.

In some embodiments, when the interfaces 2122, 2142 and 2162 are APIs, the integration tool 200 can use the APIs through the invoking interface 202, and then use the corresponding verification tools 212, 214 or 216.

In some embodiments, when the interfaces 2122, 2142 and 2162 are command line invoking interfaces, the integration tool 200 can use scripts to input commands to the interfaces 2122, 2142 and 2162 and then use the corresponding verification tools 212, 214 or 216.

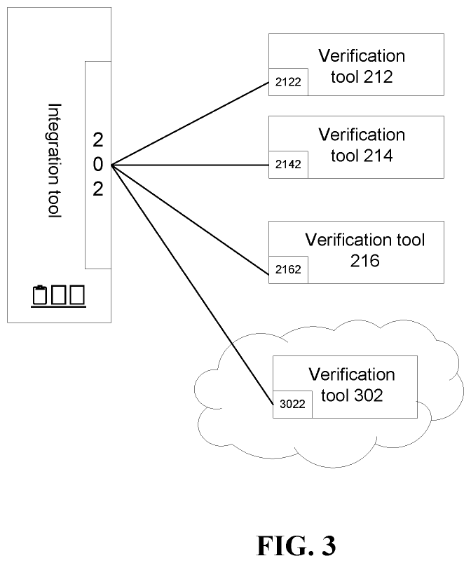

FIG. 3 illustrates a schematic diagram of a verification tool 302 on the cloud according to embodiments of the present disclosure. As shown in FIG. 3, the integration tool 202 is communicatively connected to the verification tool 302 on the cloud through the invoking interface 202 of the integration tool 202 and an interface 3022 of the verification tool 302, so that the capability of the verification tool 302 can be used remotely.

In some embodiments, when a user uses the integration tool 200 to invoke a verification tool, the verification tool may not be installed on the electronic device 100. The verification tool that has not been installed can be a tool that the user does not use frequently. The integration tool 200 can also invoke tools provided by EDA tool providers through a cloud service on the cloud via the network. That is, the integration tool 200 can invoke tools on the cloud via the invoking interface 202.

In some embodiments, to invoke multiple verification tools, the integration tool 200 can receive a verification goal of a user, and invoke multiple verification tools according to the verification goal.

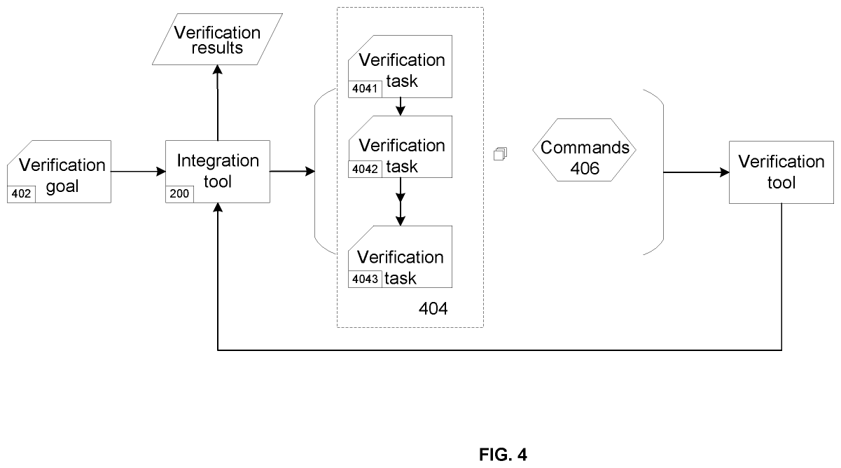

FIG. 4 illustrates a schematic diagram of a process 400 for processing a verification goal according to embodiments of the present disclosure.

As shown in FIG. 4, the integration tool 200 can receive a verification goal 402 from a user (not shown). The verification goal 402 can be, for example, to detect whether a chip design can pass all the test cases and pass the static verification under the condition that the line coverage rate being more than 90% in the dynamic verification.

According to the verification goal 402, the integration tool 200 can invoke a plurality of verification tools (e.g., verification tools 212, 214, 216 302, or the like) via the invoking interface 202. In some embodiments, the integration tool 200 can analyze the verification goal 402 to determine a plurality of verification tasks 404 associated with the verification goal 402 (e.g., verification tasks 4041-4043) and the execution order of the plurality of verification tasks 404 (as indicated by the arrows between verification tasks 4041-4043).

For example, the above-mentioned verification goal 402 can be decomposed by the integration tool 200 into several parts: dynamic verification by a software simulation tool (i.e., a verification task 4041), static verification by a formal verification tool (i.e., a verification task 4042), and sending failed assertions or test cases of the dynamic verification and static verification to a debugging tool (i.e., verification task 4043). An initial execution order of the above parts can be sequential. It is appreciated that a verification task can include all inputs (e.g., chip design source code, assertions, test bench (TB), test cases, or the like) required to perform the task.

In addition to multiple verification tasks and the execution order, the integration tool 200 can also correspondingly generate commands 406 for operating the corresponding verification tools.

In some embodiments, the multi-tool verification process can include the multiple verification tasks 404, the execution order, and the commands 406 as described above. Therefore, the integration tool 200 can generate a multi-tool verification process based on the verification goal and the plurality of verification tools.

In some embodiments, verification tools 212, 214, 216 or 302 can be shared as underlying computing resources; or even verification tools 212, 214, 216 or 302 can be cloud computing resources. This means that the verification tool 212, 214, 216 or 302 is not necessarily available at the moment when the verification goal 402 is received.

Accordingly, the integration tool 200 can also determine the status of multiple verification tools 212, 214, 216, or 302. The status of a verification tool can include, for example, a running status, an occupied status, or the like. The running status can include running or not running. For a verification tool in running, its occupancy status can further include estimated available time and the like.

According to the status of the multiple verification tools, the integration tool 200 can adjust the multi-tool verification process described above. For example, according to the communication between the integration tool 200 and the multiple verification tools, the integration tool 200 finds that the software simulation tool and the formal verification tool are available at the present time until some point in the future, and the integration tool 200 can adjust the multi-tool verification process to modify the verification tasks 4041 and 4042 from initial sequential execution to parallel execution. As another example, verification goals can be prioritized. The integration tool 200 can adjust the multi-tool verification process to temporarily suspend the verification task 4043 when a verification goal with a higher priority request to invoke, for example, a debug tool.

In some embodiments, the integration tool 200 can adjust the multi-tool verification process according to the results of executed verification tasks. For example, when the verification task 4041 is executed, the integration tool 200 can obtain the result of the verification task 4041. However, the result shows that the coverage rate is significantly lower than expected, and thus, the integration tool 200 can adjust the test case generation strategy, to regenerate new test cases and re-execute a new verification task to achieve the required coverage rate.

It can be understood that, in the above process, the user can directly issue instructions or commands to intervene or change the execution of the multi-tool verification process.

Therefore, the integration tool 200 can comprehensively decide when to invoke which verification tool according to verification tasks, user instructions, available software and hardware resources, and built-in automatic intelligent logic, so as to realize a verification process with a dynamic schedule.

The integration tool 200 can also provide some preset libraries, graphical user interface (GUI) templates, and the like, allowing the user to invoke these libraries and GUIs by inputting scripts, command lines, or configuration files, so that the verification capabilities provided by tools 212, 214, and 216 can be built into customized verification functions and orders. In some embodiments, different users have different processes for verifying their own design projects, such as specific verification goals being completed with the specified verification tools; different modules of a design project being verified with an order; or specifying verification tools to take different follow-up steps based on the verification result output (e.g., starting a debugging tool for debugging test cases having errors). And these different user processes can be achieved by the customized functions of the integration tool 200.

It is appreciated that the integration tool 200 and the verification tools 212, 214 and 216 can all run on the electronic device 100. In some embodiments, the verification tool 302 can run on the cloud.

Corresponding verification results can be generated after the verification tools 212, 214 and 216 are invoked. The verification results can be presented in data forms, such as waveform data. The integration tool 200 can also be configured to separately collect sub-verification data of the verification tools 212, 214 and 216, and integrate the sub-verification data into unified verification data. Because the verification goal is usually measured by function coverage and code coverage, the integration tool 200 can determine the next verification invoking process according to the unified verification data results. In the process, if a verification tool (212, 214, or 216) has already achieved the verification goal (i.e., the verification function or codes being covered by the verification), there is no need to repeat the verification in other verification tools. Through such a process, the verification work required by a single verification tool can be effectively reduced.

Furthermore, the integration tool 200 can also intelligently select the most matching verification tool to complete a verification goal, according to the characteristics of the verification goal and the currently available resources of each verification tool (such as the number of software licenses or the number of hardware resources), so as to maximize the verification efficiency.

Embodiments of the present disclosure also provide a method for verifying logic system design.

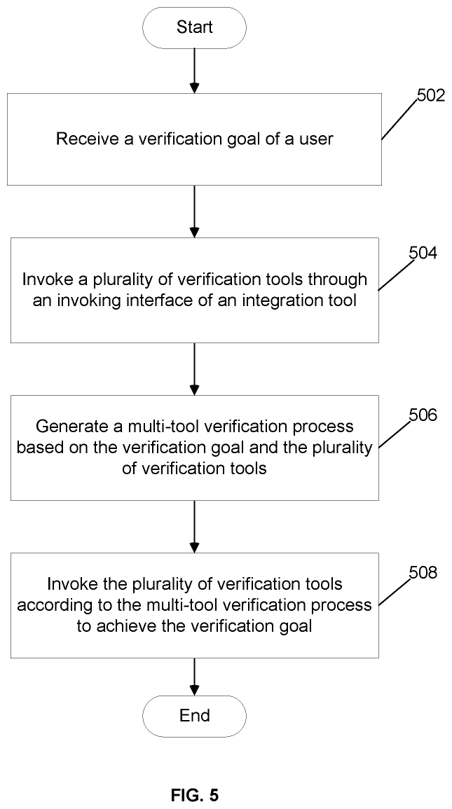

FIG. 5 illustrates a flowchart of a method 500 for verifying a logic system design according to embodiments of the present disclosure. The method 500 can be executed by the electronic device 100 shown in FIG. 1, more specifically, by an integration tool running on the electronic device 100 (for example, the integration tool 200 shown in FIG. 2). The method 500 can include the following steps.

At step 502, the electronic device 100 can receive a verification goal (e.g., the verification goal 402 of FIG. 4) of a user. The verification goal can be a testing goal (e.g., meeting a functional coverage rate) of the chip design. It is appreciated that the chip design can be continuously modified during the verification process to ultimately achieve the verification goal.

At step 504, according to the verification goal, the electronic device 100 can invoke a plurality of verification tools (e.g., the verification tool 212, 214, 216 or 302 of FIGS. 2 and 3) through the invoking interface of the integration tool 200. In some embodiments, the first verification tool of the plurality of verification tools is a tool provided remotely on the cloud (e.g., verification tool 302 of FIG. 3).

In some embodiments, the plurality of verification tools can respectively have interfaces (e.g., interfaces 2122, 2142, 2162 in FIG. 2 or 3) for the integration tool to invoke the plurality of verification tools. The interface can be an application programming interface or a command line invoking interface.

In some embodiments, to invoke the plurality of verification tools, the electronic device 100 can analyze the verification goal to determine a plurality of verification tasks associated with the verification goal (e.g., verification tasks 4041-4043 shown in FIG. 4) and the execution order (as shown by the arrows in FIG. 4) of the verification tasks associated with the verification goal; and determine the plurality of verification tools to be invoked according to the plurality of verification tasks and the execution order.

At step 506, the electronic device 100 can generate a multi-tool verification process based on the verification goal and the plurality of verification tools.

In some embodiments, to generate a multi-tool verification process, the electronic device 100 can determine the status of the plurality of verification tools; and adjust the multi-tool verification process according to the results of the executed verification tasks and the status of the plurality of verification tools.

As mentioned above, according to the status of the verification tools (for example, a certain tool being temporarily occupied by a verification task with a higher priority), the integration tool 200 can adaptively adjust the multi-tool verification process. Accordingly, the verification goal can have a specific priority. The status of the verification tool can include a running status, an occupancy status, or the like. The running status can include running or not running. For a verification tool that is running, the occupancy status can further include expected available time (for example, when it can be used, and the available time period, or the like).

At step 508, the electronic device 100 can invoke the plurality of verification tools according to the multi-tool verification process to achieve the verification goal.

The verification tools can also return to integration tools the results of verification tasks that have been performed. In some embodiments, when the results of the performed verification tasks cannot meet the requirements, the integration tool 200 can automatically modify the multi-tool verification process or invite the user to manually modify the multi-tool verification process.

In some embodiments, the integration tool 200 can also collect sub-verification data of the plurality of verification tools; and integrate the sub-verification data of the plurality of verification tools into unified verification data. The sub-verification data can be, for example, partial waveform of a partial design, and the unified verification data can be the full waveform of a complete design.

The integration tool can also generate a graphical user interface according to the status of the plurality of verification tools and the result of the executed verification task.

By integrating and further modifying the capabilities of multiple verification tools through the integration tool, users can flexibly design verification functions they need, which improves the efficiency of the verification of the logic system design for the users. In addition, when a user temporarily lacks a verification tool locally, the integration tool provided by the embodiments of the present disclosure can also invoke the verification tool on the cloud to meet the temporary needs of users. It is appreciated that, in some embodiments, all verification tools can be provided on the cloud. In addition, the integration tool can also be provided on the cloud.

It should be noted that, the method of the present disclosure can be executed by a single device, for example, a computer, a server, and the like. The method of the embodiments can also be applied in a distributed scenario and be implemented by a plurality of devices which can cooperate with each other. In the distributed scenario, one of the plurality of devices can only perform one or more steps in the method of the present disclosure, and the plurality of devices will interact with each other to implement the method.

The embodiments of the present disclosure also provide an electronic device. The electronic device includes: a memory storing a set of instructions; and at least one processor configured to execute the set of instructions to perform the method as described above.

The computer-readable medium in the present disclosure includes permanent and non-permanent storage media storing computer instructions that can implement the above method when executed. The storage medium, for example, include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM, digital versatile disc (DVD) or other optical storage, magnetic cassettes, magnetic tape magnetic disk storage or other magnetic storage devices or any other non-transmission media can be used to store information that can be accessed by computing devices.

The specific embodiments of the present disclosure are described above. Other embodiments are within the scope of the disclosure. In some circumstances, the actions or steps in the disclosure can be executed in a different order from the embodiments and still achieve the desired result. In addition, the process depicted in the drawings does not require the specific order or sequential order to achieve the desired results. In some embodiments, multitasking and parallel processing are also possible or can be advantageous.

It can be appreciated for those ordinary skilled in the art: any embodiments discussed above are merely exemplary and do not indicate that the scope of the present disclosure is limited by these embodiments; under the idea of the present disclosure, embodiments or the technical features in different embodiments above can make a combination, the steps can be implemented in any order, and can have different changes in different aspects of the present disclosure as described above, and for brevity, there are not provided in details.

In addition, to simplify the description and discussion, the well-known power source/ground connected to integrated circuit (IC) chips and other components may or may not be shown in the provided drawings. In addition, the devices can be shown in the form of diagrams to avoid making the present disclosure difficult to understand, and this also takes the following facts that the details (that is, the details are understood by those ordinary skilled in the art) of the implementation of these devices in diagrams are highly dependent on the platform which will implement the present disclosure into consideration. Under the circumstance that details (for example, circuits) are described to describe exemplary embodiments of the present disclosure, it is obvious to those skilled in the art that it can be possible to implement the present disclosure without these specific details or upon these specific details are changed.

Although the present disclosure has been described in conjunction with specific embodiments of the present disclosure, the plurality of substitutions, modifications, and variations of these embodiments can be obvious to those skilled in the art according to the foregoing description. For example, other memory architectures (e.g., dynamic RAM (DRAM)) can be used in the discussed embodiments.

The present disclosure is intended to cover all such substitutions, modifications and variations that fall within the broad scope of the disclosure. Therefore, any omission, modification, equivalent replacement, improvement, and the like within the spirit and principle of the present disclosure should be included in the scope of the present disclosure.

What is claimed is:

1. A method of verifying a logical system design, comprising:
receiving a verification goal of a user;
according to the verification goal, invoking a plurality of verification tools through an invoking interface of an integration tool;
generating a multi-tool verification process based on the verification goal and the plurality of verification tools; and
invoking the plurality of verification tools according to the multi-tool verification process to achieve the verification goal.

2. The method according to claim 1, wherein, according to the verification goal, invoking the plurality of verification tools through the invoking interface of the integration tool further comprises:
analyzing the verification goal to determine a plurality of verification tasks associated with the verification goal and an execution order of the plurality of verification tasks; and
determining the plurality of verification tools to be invoked according to the plurality of verification tasks and the execution order.

3. The method according to claim 2, wherein generating the multi-tool verification process based on the verification goal and the plurality of verification tools further comprises:
determining status of the plurality of verification tools; and
adjusting the multi-tool verification process according to results of executed ones of the plurality of verification tasks and the status of the plurality of verification tools.

4. The method according to claim 3, further comprising:
generating a graphical user interface according to the status of the plurality of verification tools and the results of the executed ones of the plurality of verification tasks.

5. The method according to claim 1, wherein one of the plurality of verification tools is a tool remotely provided on the cloud.

6. The method according to claim 1, wherein the plurality of verification tools have interfaces, respectively, for the integration tool to invoke the plurality of verification tools.

7. The method according to claim 1, further comprising:
collecting sub-verification data of the plurality of verification tools via the integration tool; and
integrating the sub-verification data of the plurality of verification tools into unified verification data.

8. The method according to claim 1, wherein the verification goal is associated with a specific priority.

9. An electronic device for verifying a logical system design, comprising:
a memory storing a set of instructions; and
at least one processor configured to execute the set of instructions to:
receive a verification goal of a user;
according to the verification goal, invoke a plurality of verification tools through an invoking interface of an integration tool;
generate a multi-tool verification process based on the verification goal and the plurality of verification tools; and
invoke the plurality of verification tools according to the multi-tool verification process to achieve the verification goal.

10. The electronic device of claim 9, wherein, to invoke the plurality of verification tools through the invoking interface of the integration tool, the at least one processor is further configured to execute the set of instructions to:
analyze the verification goal to determine a plurality of verification tasks associated with the verification goal and an execution order of the plurality of verification tasks; and
determine the plurality of verification tools to be invoked according to the plurality of verification tasks and the execution order.

11. The electronic device according to claim 10, wherein to generate the multi-tool verification process based on the verification goal and the plurality of verification tools, the at least one processor is further configured to execute the set of instructions to:
determine status of the plurality of verification tools; and
adjust the multi-tool verification process according to results of executed ones of the plurality of verification tasks and the status of the plurality of verification tools.

12. The electronic device according to claim 11, wherein the at least one processor is further configured to execute the set of instructions to:
generate a graphical user interface according to the status of the plurality of verification tools and the results of the executed ones of the plurality of verification tasks.

13. The electronic device according to claim 9, wherein one of the plurality of verification tools is a tool remotely provided on the cloud.

14. The electronic device according to claim 9, wherein the plurality of verification tools have interfaces, respectively, for the integration tool to invoke the plurality of verification tools.

15. The electronic device according to claim 9, wherein the at least one processor is further configured to execute the set of instructions to:
collect sub-verification data of the plurality of verification tools via the integration tool; and
integrate the sub-verification data of the plurality of verification tools into unified verification data.

16. The electronic device according to claim 9, wherein the verification goal is associated with a specific priority.

17. A non-transitory computer-readable storage medium storing a set of instructions that, when executed by a processor, causes the processor to perform a method for verifying a logical system design, the method comprising:
receiving a verification goal of a user;
according to the verification goal, invoking a plurality of verification tools through an invoking interface of an integration tool;
generating a multi-tool verification process based on the verification goal and the plurality of verification tools; and
invoking the plurality of verification tools according to the multi-tool verification process to achieve the verification goal.
